(19) United States
(12) Patent Application Publication
(10) Pub. No.: US 2010/0259412 A1
(43) Pub. Date: Oct. 14, 2010

(54) SYSTEMS AND METHODS FOR ATHLETIC CONTESTS

(75) Inventor: Joseph G. Pagonakis, Medina, OH (US)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Hoopzilla, LL, Medina, OH (US)

(21) Appl. No.: 12/437,407

(22) Filed: May 7, 2009

Related U.S. Application Data
(60) Provisional application No. 61/168,067, filed on Apr. 9, 2009.

(51) Int. Cl. G05B 19/04

(52) U.S. Cl. 340/825.24

(57) ABSTRACT

One embodiment relates to an electronic system for basketball contest. The electronic system includes a communication device adapted to be mounted on a basketball goal. The communication device includes: at least one sensor adapted to provide a sensor signal indicative of interaction of a basketball with the basketball goal, as well as a transmitter adapted to transmit a wireless control signal in response to the sensor signal. In addition, the electronic system includes a receiver adapted to receive the wireless control signal and, based on the wireless control signal, provide a trigger signal adapted to induce a change in an audio output provided by a programmable audio player.

### RELATED APPLICATIONS

This application claims priority to a U.S. Provisional Application having Application No. 61/168,067, which was filed on Apr. 9, 2009 and entitled “INTERACTIVE BASKETBALL HOOP/HOCKEY GOAL/SOCCER GOAL MP3/IPOD REMOTE CONTROL”. This provisional application is incorporated by reference in its entirety.

### FIELD OF THE DISCLOSURE

The present invention relates generally to techniques to be used in athletic contests having a goal, and more particularly to techniques that induce a change in an audio output based on how an object used in the athletic contest interacts with the goal.

### BACKGROUND

America is home to the most obese people in the world. According to the Centers for Disease Control, obesity in adults has more than doubled since 1985, and obesity in children has approximately tripled since 1975. Recent studies have found that just less than twenty-percent of children in our country today are overweight. Although there are many factors that contribute to obesity, obesity is the often result of caloric imbalance—too few calories are expended in comparison to how many calories are consumed. Healthy lifestyle habits, including healthy eating and physical activity, can lower the risk of becoming obese and developing related diseases.

On activity that expends a significant number of calories is basketball. As will be further appreciated herein, the inventors have devised improved techniques that are applicable to basketball (as well as other sports), thereby promoting increased physical activity. For purposes of background, several known basketball systems are described below.

Heiman, U.S. Pat. No. 6,816,442 teaches the exclusive use of wristband wireless remote controls, worn by players to start and stop a game timing device and thus control audio announcements during a game.

Calace, U.S. Pat. No. 6,603,711 and Poole, U.S. Pat. No. 6,369,697 also teach the use of wireless transmitting remotes. Each of these devices transmits a signal to control a timing device during a game.

McMahan, U.S. Pat. No. 5,418,517, teaches the use of a force activated sensor on a basketball goal to trigger crowd cheering or other sound effects.

Matherne, U.S. Pat. No. 5,418,517 teaches the use of a piezoelectric or vibration sensor that detects successful basketball shots and signals a scoreboard.

Hampson, U.S. Pat. No. 6,052,054 teaches the use of a motion sensor that sends a wireless signal to an alarm to prevent theft of a scoreboard.

Hampton, U.S. Pat. No. 6,389,368 teaches the use of a vibration sensor that triggers a transmitter to send information on a basketball player's shooting statistics. This information is then fed to a score keeping apparatus.

Strong, U.S. Pat. No. 6,945,882 teaches the use of wireless radio controllers worn by basketball players to account for made or missed basketball shots. Also, when a selected time period elapses, an audio signal is broadcast through the speaker.

Jordan, U.S. Pat. No. 6,984,129 teaches the use of a mechanical scoring sensor on a basketball goal that triggers lights or LED's and cheering. Jordan also keeps track of shot accuracy and score keeping.

McDonald, U.S. Pat. No. 7,031,225 teaches the use of wireless remote radio transmitters that are used by officials and umpires to control timers and scoreboards.

Cabrera, U.S. Pat. No. 6,582,329 teaches the use of a photoelectric hoop sensor that activates a timer. An audio announcement and indicator lights are triggered when a basket is made.

Mele, U.S. Pat. No. 4,904,981 teaches the use of an infrared sensor on a basketball hoop. The sensor is used to trigger scoring data, a timing device, and storage of data in a basketball game. Another Mele reference, U.S. Pat. No. 4,999,603 teaches the use of a laser beam detector on a basketball hoop.

The inventors have appreciated that while these prior art techniques may be sufficient for their stated purposes, they are all less than optimal for encouraging obese children and young adults to become more active.

### SUMMARY

The inventors have appreciated that many obese children and young adults own computers, video gaming systems, and .mp3 players. For example, as of September 2008, more than 173,000,000 units of the popular IPOD-brand .mp3 player have been sold worldwide. Whereas current public opinion often places blame for obesity on electronic gadgets, which allegedly tend to promote sedentary lifestyles, the inventors have devised new uses for such devices to help combat obesity, particularly in young people. In this manner, the inventors have come up with techniques that incorporate technology already owned by young people, such as .mp3 players, to help young get more physical activity.

Some techniques disclosed herein induce a change in music played during a basketball game based on how a basketball interacts with a basketball goal. The interaction of the basketball with the basketball goal can include missed shots, made shots, or any other type of impact between the basketball and the basketball goal. Moreover, in some implementations this functionality is enabled by a communication device having structural features that allow it to be easily mounted and de-mounted from the basketball goal. In this way, techniques disclosed herein allow players to use a portable communication device that is compatible with their existing .mp3 player (e.g., an IPOD-brand .mp3 player) to coordinate music in a pickup basketball game on their home or neighborhood basketball court.

As set forth above in the background, several prior art references teach controlling a scoreboard or a timing device during a basketball game. However, no known prior art reference is believed to teach controlling musical tracks on an .mp3 player based on the interaction of a basketball with an athletic goal. Further, none of the prior art references teach a portable system that allows players to easily provide such coordinated music at a remote basketball court. By encouraging young people to become more active in sports such as basketball, it is hoped that the concepts disclosed herein can increase the amount of physical activity for young people, for example by an hour or two each week, which may help to reduce obesity and improve the quality of life for millions of Americans.

### BRIEF DESCRIPTION OF THE DRAWINGS

FIG. 1 is a diagram of a communication device capable of inducing a change in a programmable audio player in the context of a basketball contest.

FIGS. 2-4 are diagrams illustrating various techniques for mounting a communication device on a basketball goal.

FIG. 5 is a diagram of foot petal assembly that can be used in conjunction with athletic contests.

FIG. 6 is a diagram of another electronic system that includes a foot pedal assembly and a communication device in the context of a basketball contest.

### DETAILED DESCRIPTION

Some aspects of the present invention will now be described with respect to the accompanying drawings in which like numbered elements represent like parts.

For purposes of illustration, several figures illustrated herein show a basketball goal 100, which is merely one example of an athletic goal as contemplated as falling within the scope of the present disclosure. The basketball goal 100 includes a pole 102 having a backboard 104 mounted thereto, a rim 106, and a net 108. During game play, players attempt to shoot a ball 110 through a central opening in the rim 106 and into the net 108. In this manner, players score points for their respective teams. Ultimately, the team that scores the most points during game play wins. The inventors have appreciated that, until now, basketball systems have been lacking efficient techniques for monitoring interaction between the ball 110 and the goal 100 (and optionally between at least one person involved in the contest), and for altering the audio experience for people based on this interaction. By improving how this interaction is monitored and by adjusting music correspondingly, it is hoped that children and other young adults will be more active in basketball, thereby reducing obesity.

Several different types of monitoring this interaction are discussed below. It will be appreciated that these embodiments may be combined in various manners. In addition, not all features described and illustrated below are required in all embodiments. Thus, the figures and accompanying description of the figures are provided for only illustrative purposes.

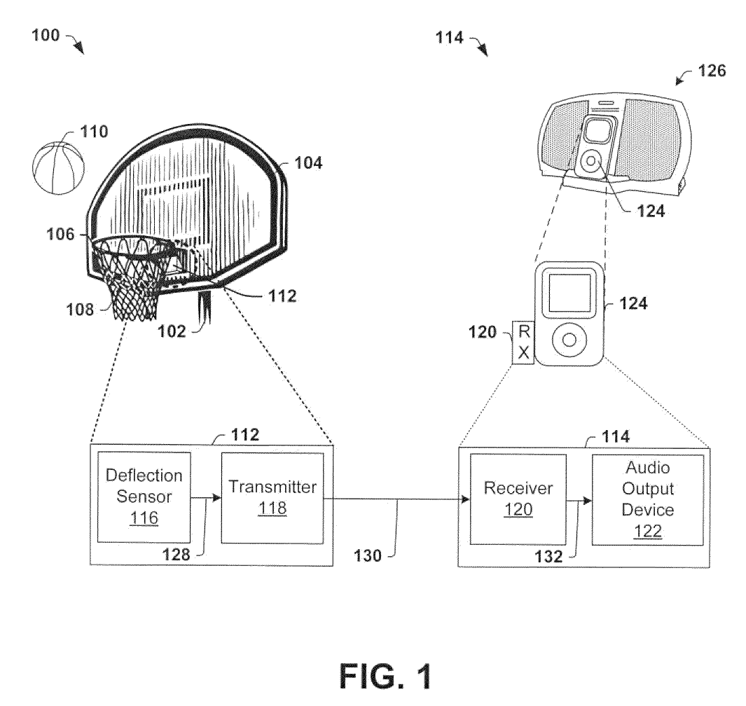

Turning now to FIG. 1, one can see a basketball goal 100 associated with a communication device 112 adapted to induce a change in an audio output of a programmable audio player 114. In this embodiment, the communication device 112 includes a deflection sensor 116 and a transmitter 118. Although the illustrated embodiment shows a deflection sensor 116 (which detects “missed shots”), it will be appreciated that “made shots” or any other type of interaction between the ball and the goal can also be monitored.

The programmable audio player 114 includes a receiver 120 and an audio output device 122. For purposes of illustration, FIG. 1 shows an example where the audio output device 122 includes an .mp3 player 124 (e.g., an iPOD-brand .mp3 player), which can optionally be coupled to a base station and/or speakers 126 external to the .mp3 player 124.

During operation, the deflection sensor 116 is adapted to generate a deflection signal 128 that is indicative of whether the ball 110 deflects from the basketball goal 100 without passing through the central opening in the rim 106, which may also be referred to as a “missed shot”. Upon receiving the deflection signal 128, the transmitter 118 transmits a wireless or wired control signal 130 to the receiver 120. The receiver 120, in turn, provides a trigger signal 132 (based on the control signal 130) to the audio output device 122. This trigger signal 132 induces a change in the audio output device 122, which change is typically perceivable by at least one person associated with the game. For example, in embodiments where the programmable audio player 114 includes an .mp3 player, the trigger signal 132 can cause the .mp3 player to change an audio track playing to a different audio track. In this manner, music can be provided to players, officials, or spectators to suitably correspond to interaction between the ball and the basketball goal (e.g., missed shots). This may help to add to the overall experience of the players and/or spectators, thereby giving a more enjoyable athletic experience.

In some embodiments, the deflection sensor 116 is a vibration sensor that is operable to detect when the ball 110 deflects from the basketball goal 100. In other embodiments, the deflection sensor 116 is another type of sensor, such as an optical sensor, audio sensor, electromagnetic sensor, or piezoelectric sensor, for example.

In some embodiments, if the programmable audio player 114 does not learn of a deflected shot occurring within some predetermined time period as measured from a previous deflected shot, made basket, or other contestant-initiated event; the programmable audio player 114 can change the audio output (e.g., audio track) on its own merit without regard for the control signal 130.

In several implementations the communication device 112 can be a portable device that is part of an audio accessory kit, such as an .mp3 accessory kit. This kit often includes the communication device 112, the receiver 120, and several other components (e.g., software on a computer readable medium, cables, other sensors or transmitters). In such instances, the communication device 112 is often encased in a housing, which is operable to allow the communication device 112 to be removably coupled and decoupled from the basketball goal 100. Typically, the housing can be water-resistant and/or shock-resistant. The housing may encase the transmitter 118, at least one sensor (e.g., deflection sensor 116), and a battery compartment for housing a battery that powers the communication device 112. Although other embodiments could include an AC adapter, the use of a battery makes the communication device 112 easy to use at remote basketball courts and makes the communication device 112 easy to mount on the basketball goal 100.

In other implementations, rather than being a portable device, the communication device 112 can be fixedly (e.g., permanently) incorporated into the basketball goal itself. For example, the transmitter 118 and a sensor (e.g., deflection sensor 116) could be fixedly mounted into the basketball goal 100, such as on the backboard 104, rim 106, or pole 102, for example.

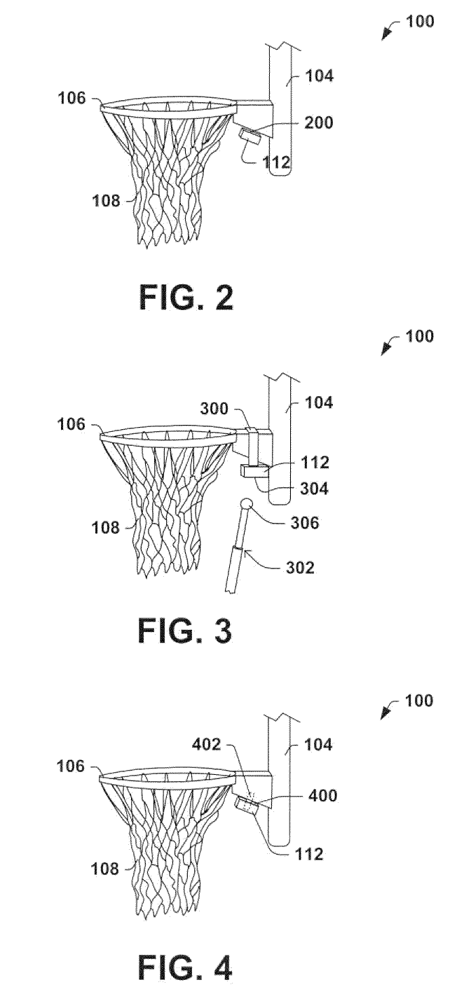

Turning now to FIGS. 2-4, one can see several more detailed depictions of how a communication device 112 having a housing can be mounted on the basketball goal 100. FIGS. 2-3 show two examples where the communication device 112 is adapted to be removably coupled and decoupled from the basketball goal 100. In FIG. 2, the housing of the communication device 112 includes an engagement surface 200 adapted to removably couple and decouple the communication device 112 to and from the basketball goal 100. In some embodiments the engagement surface 200 comprises a magnet that removably couples the communication device 112 to the rim 106, but in other embodiments the engagement surface 200 comprises VELCRO-brand hook and loop fasteners, easily detachable clips, or another type of removable coupling element.

FIG. 3 shows another mounting technique where the communications device 112 includes a hook or hanger element 300 that allows the communication device to be removably coupled and decoupled from the basketball goal 100. FIG. 3 also shows a telescopic member 302 that engages a hoisting surface 304 on the communications device 112. In some implementations, an end surface 306 of the telescopic member 302 can interface with recess(es) (and/or protruding member(s)) on the hoisting surface 304 to allow a person to mount the communication device 112 on the basketball goal 100 without the need for a ladder. For example, in one embodiment, hoisting surface 304 can include a push and turn keyhole connector that interfaces with the telescopic member. Again, this helps make the communication device 112 easy to use at remote basketball courts and makes the communication device 112 easy to mount on the basketball goal 100. Although not shown in the other figures, the telescopic member 302 and/or hoisting surface 304 can be used with other embodiments as well.

FIG. 4 illustrates another embodiment where the communications device 112 is fixedly mounted to the basketball goal 100. In particular, in FIG. 4 the communication device 112 includes an engagement surface 400 having a fastening element 402. The illustrated fastening element 402 (e.g., a screw, or nut and bolt) extends from the engagement surface 400 into a portion of the basketball goal (e.g., into the rim 106). In other embodiments, a fastening element 402 is a u-shaped bolt or other fastening element that extends around a portion of the basketball goal 100 to achieve this fixed mounting. Although FIG. 4 shows a single fastening element, more than one fastening element may be present.

Although FIGS. 2-4 show several examples where the communication device 112 is mounted under a horizontal portion of the rim 106 adjoining the backboard 104, in general, the communication device 112 can be mounted anywhere that is suitable to detect interaction between the ball 100 and the basketball goal 100. For example, the communication device 112 could also be mounted in or to the pole 102, on the net 106, on a corner of the backboard 104, or on a face of the backboard 104 other than the face to which the rim 106 is attached, among others. In addition, although a detection sensor 116 is described above, the communication device 112 can also be compatible with other sensors that may be included in the kit, such as a goal detection sensor that detects when the ball passes through the rim into the net, for example.

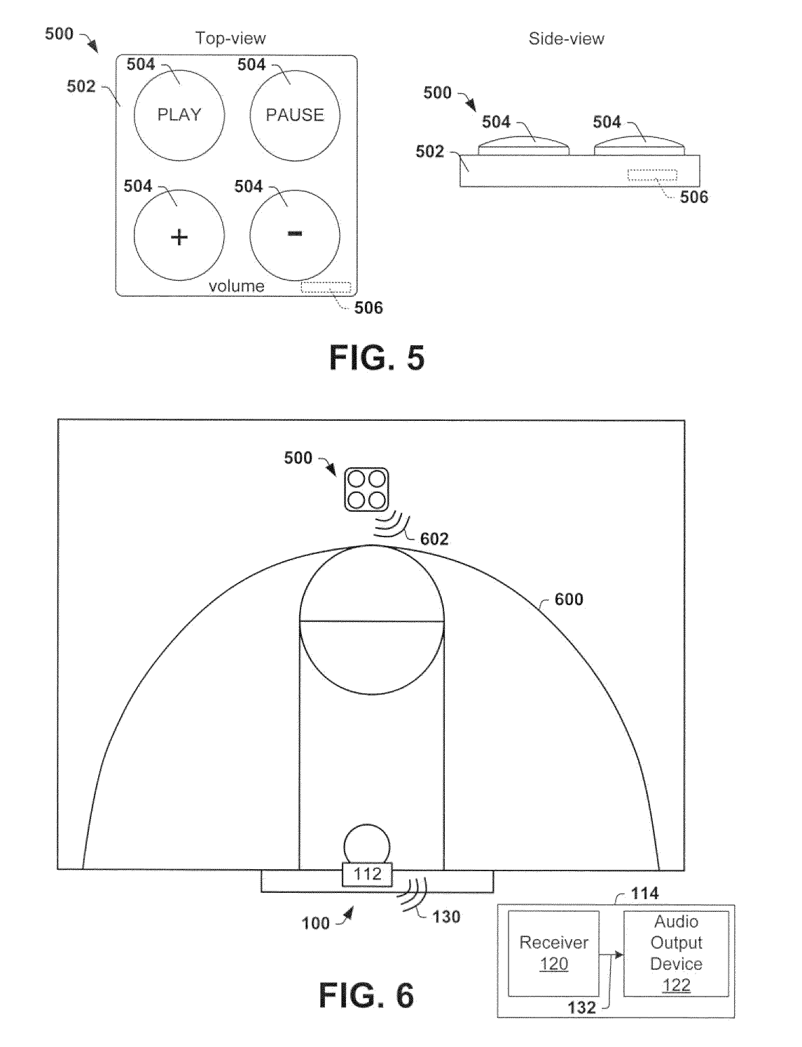

Turning now to FIG. 5-6, one can see another embodiment that includes additional functionality. More specifically, this embodiment makes use of at least one foot pedal element 500 capable of more precisely tailoring the audio output to user initiated input during the game. Again, in this or other manners, the present disclosure includes communication devices that enable a more enjoyable athletic experience, which may promote active lifestyles to reduce obesity.

In FIG. 5, the foot pedal element 500 includes a housing 502 and a number of push buttons 504. Generally, the housing 502 can be water-resistant and shock-resistant, and may include a battery compartment 506 for storing one or more batteries that are capable of powering the foot pedal element 500 at a remote location. The housing 502 also includes a transmitter (e.g., a wireless RF transmitter), by which the foot pedal can interact with the programmable audio player 114 as described further herein with respect to FIG. 6.

In FIG. 5's illustrated embodiment, the pushbuttons 504 include a play button, a pause button, a volume up button, and a volume down button. However, it will be appreciated that other push buttons can also be included in some embodiments, and not all of the illustrated push buttons are present in other embodiment. Generally, the push buttons are of sufficient size to be easily actuated by a foot of a basketball player during a basketball contest. For example, in one embodiment, each push-button 504 could be approximately 2-inches in diameter, and the housing 502 could measure approximately 8-inches in length along a given side, although virtually any size could be used for these diameters and lengths.

Turning now to FIG. 6, a more detailed description of game play with the foot pedal element 500 is discussed with reference to a half-court basketball “pick-up” game, wherein both teams use a single basketball goal 100. During these types of games, when possession changes from one team to the other (e.g., if a steal or defensive rebound occurs) the team taking possession is often required to take the ball back beyond some pre-determined distance from the goal.

For purposes of understanding, FIG. 6's example is described with respect to this pre-determined distance being a three-point line 600. Thus, when a team takes initially take possession, a member of the team with the ball actuates a push button 504 on the foot petal 500, which indicates the ball is successfully “taken back.” In response, the transmitter in the foot pedal element 500 transmits a second control signal 602 to the receiver coupled to the programmable audio player 114. The receiver 120 again sends a trigger signal 132 to the audio output device 122, which in turn can then alter the audio output for the players.

In addition to the foot pedal element 500, FIG. 6's embodiment also illustrates the previously discussed communication device 112, which can send a first control signal 130 to the receiver 120 as previously discussed. Thus, in some embodiments the receiver 120 and audio output device 122 are capable of distinguishing between the first and second control signals 130, 602, respectively, and intelligently processing these control signals to adapt the audio output to real-time events in the game.

For purposes of illustration, the disclosure has been illustrated in the figures and described above with respect to an athletic contest that is a basketball game. However, the concepts of the invention are equally applicable to other athletic contests that use an athletic goal having a scoring region. For example, the invention is also equally applicable to hockey, lacrosse, and soccer, as well as a host of other athletic contests.

In addition, although several examples have been illustrated and described above where the programmable audio player 114 comprises an .mp3 player, it will be appreciated that other programmable audio players (e.g., CD players, radios, video players, visual displays) are also contemplated as being legal equivalents of an .mp3 player.

Although the invention has been shown and described with respect to a certain aspect or various aspects, equivalent alterations and modifications will occur to others skilled in the art upon the reading and understanding of this specification and the annexed drawings. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

What is claimed:

1. An electronic system for basketball contest, comprising:
a communication device adapted to be mounted on a basketball goal and comprising: at least one sensor adapted provide a sensor signal indicative of interaction of a basketball with the basketball goal; and a transmitter adapted to transmit a wireless control signal in response to the sensor signal; and
a receiver adapted to receive the wireless control signal and, based on the wireless control signal, provide a trigger signal adapted to induce a change in an audio output provided by a programmable audio player.

2. The electronic system of claim 1, where the programmable audio player is adapted to play audio clips having an .mp3 file format.

3. The electronic system of claim 1, where the communication device comprises: a housing having an engagement surface that includes a magnet to removably mount and un-mount the communication device to and from the basketball goal.

4. The electronic system of claim 3, where the communication device comprises: a housing that includes a battery compartment adapted to store a battery for powering the communication device.

5. The electronic system of claim 1, further comprising:
a foot pedal element that includes a pushbutton, where the foot pedal element is adapted to provide a second wireless control signal in response to actuation of the pushbutton.

6. The electronic system of claim 1, where the at least one sensor comprises a deflection sensor adapted detect when the basketball deflects from the basketball goal without passing into a scoring region of the basketball goal.

7. A communication device for use in an athletic contest, comprising:
a sensor adapted detect when an object interacts with an athletic goal and further adapted to provide a sensor signal indicative of the interaction;
a transmitter adapted to provide a control signal based on the sensor signal, where the control signal is adapted to induce a change in an output of an programmable .mp3 audio player.

8. The communication device of claim 7, where the sensor comprises at least one of: a vibration sensor, an optical sensor, an audio sensor, or an electromagnetic sensor.

9. The communication device of claim 7, where the communication device further comprises:
an engagement surface adapted to removably couple and decouple the communication device to and from the athletic goal.

10. The communication device of claim 9, where the engagement surface comprises a magnet.

11. The communication device of claim 7, where the communication device further comprises:
an engagement surface; and
a fastening element extending from the engagement surface into or around a surface of the athletic goal to fixedly couple the communication device to the athletic goal.

12. The communication device of claim 7, where the communication device is adapted to be operated via a battery.

13. The communication device of claim 12, where the sensor, the transmitter and a battery compartment adapted to store the battery are enclosed within a housing of the communication device.

14. The communication device of claim 7, where the communication device further comprises:
a hoisting surface adapted to engage a telescopic member for mounting the communication device on the athletic goal.

15. An electronic system for an athletic contest, comprising:
a communication device adapted to be removably coupled and decoupled to and from an athletic goal and comprising: a sensor adapted provide a sensor signal indicative of interaction between an object and an athletic goal; and a transmitter adapted to transmit a first wireless control signal in response to the sensor signal; and
a receiver adapted to receive the first wireless control signal and, in response to receiving the first wireless control signal, provide a trigger signal to an programmable audio player.

16. The electronic system of claim 15, where trigger signal is adapted to induce a change in an output of the programmable audio player which is discernable by at least one person associated with the athletic contest.

17. The electronic system of claim 15, where the programmable audio player is adapted to upload audio tracks from the Internet.

18. The electronic system of claim 15, where the communication device comprises a hoisting surface; and further comprising:
a telescopic member having a surface adapted to engage the hoisting surface and adapted to mount the communication device on the athletic goal.

19. The electronic system of claim 15, further comprising:
a foot pedal element that includes a pushbutton, where the foot pedal element is adapted to provide a second wireless control signal in response to actuation of the pushbutton.

20. A method for providing entertainment during an athletic contest, comprising:
detecting an interaction of an object with an athletic goal; and
inducing a change in an output of an battery powered .mp3 player based on the interaction of the object with the athletic goal.
